(19) United States
(12) Patent Application Publication
(10) Pub. No.: US 2008/0305828 A1
(43) Pub. Date: Dec. 11, 2008

(54) Dual-focus lens and electronic device having the same

(76) Inventors: Ching Sheng Chang, Taichung City (TW); Wei-Jie Peng, Taipei City (TW); Chih Wei Weng, Sindian City (TW)

Correspondence Address: Raymond Sun, 12420 Woodhall Way, Tustin, CA, 92782, US

(21) Appl. No.: 11/897,587

(22) Filed: Aug. 31, 2007

(30) Foreign Application Priority Data
Jun. 6, 2007 (TW) 096209275

(51) Int. Cl. H04M 1/02; G02B 3/10; H04N 5/335; G03B 13/18

(52) U.S. Cl. 455/556.1; 348/311; 348/345; 359/721; 348/E05.085; 348/E05.091

(57) ABSTRACT

A dual-focus lens includes a stop and at least two lenses. One of the lenses is relatively close to the stop, and formed with a first transmission area and a second transmission area. When the at least two lenses are fixed without shifting any lens, an image beam reflected from a first object distance can pass through the first transmission area to form a clear optical image on an image formation area located at a fixed position, and an image beam reflected from a second object distance can pass through the second transmission area to form a clear optical image on the same image formation area, so as to achieve a purpose of providing double focuses without any active elements or changing the image formation distance. Physical structures of the first transmission area and the second transmission area can be selected from the group consisting of two different thickness areas formed on an inner circle and an outer ring of one of said lenses, two different curvature areas formed on the inner circle and the outer ring, a glass having an inner circular opening close to one of said lenses to substantially provide two different thickness areas, and one Fresnel lens area and one normal lens area formed on the inner circle or the outer ring to provide two different curvature areas.

### BACKGROUND OF INVENTION

1. Field of the Invention

The present invention relates to a dual-focus lens and an electronic device having the same, and more particularly to a lens suitable to be applied to a mobile phone and capable of providing dual-focus without any active element.

2. Description of the Prior Art

Presently, with the advances of electronic technologies, various portable information electronic products and apparatuses thereof are rapidly researched and developed. Meanwhile, various components applied to the products are designed to achieve miniaturization. Thus, it is an important subject of the current market to think about how to design the products based on a more humanized concept and a concept of integrating multiple products into one unit, in order to minimize the volume of the products for conveniently carrying, satisfying the concept of ergonomics, and meeting fashion needs of customers. Especially, it is an important improvement to integrate a function of digital camera into a mobile phone, even a notebook computer or a personal digital assistant (PDA).

Nowadays, all of commercially available portable electronic devices, such as mobile phones, are developed according to a trend of miniaturization. Particularly, mobile phones having a function of digital camera are more and more popular. Furthermore, current mobile phones having the function of digital camera are further provided with a third generation (3G) wireless function, so that two users can communicate with each other by means of optical images captured by their mobile phones via a network of the mobile phones. Therefore, a future trend in the design of mobile phones is to design a mobile phone into a diversified and multi-functional apparatus which can even replace a traditional digital camera, i.e. the mobile phone may be designed into an apparatus integrated with various functions of photographing, communicating, accessing the Internet, and etc. However, most of traditional mobile phones are only provided with a lens having a fixed focus, so that it may only form an unclear image when taking a picture at a short distance (i.e. a micro-distance). Especially, when the lens of the mobile phone is applied to identify a business card, the lens must provide a function of two stage focusing. For example, referring now to FIG. 1, a traditional lens set of a camera lens 10 that only provides a function of fixed focusing (i.e. a fixed focusing lens) is illustrated. Generally, the camera lens 10 comprises a plurality of lenses, wherein a first lens has a front surface (i.e. a first surface 11) relatively close to an object, and a last lens has a rear surface (i.e. a last surface 12) relatively close to an image formation area.

Because the traditional lens set of the camera lens 10 only provides the function of fixed focusing, it can only form a clear image generated by a single focus. Hence, referring now to FIG. 2, a chart of a Modulation Transfer Function (MTF) test is illustrated, wherein a lens of 2 million pixel resolution that has a stop relatively close to the object is used as a sample and applied to the traditional camera lens 10 providing the function of fixed focusing as shown in FIG. 1 for executing the test. Then, the chart of the MTF test shows that a maximum peak value (about 0.7) of an Optical Transfer Function (OTF) modulus can only be found near a precise focus region where a focus shift value on a transverse axle is equal to 0 and a clear image can be formed, but other regions except for the precise focus region will lose focus and cannot form a clear image.

Presently, some traditional technologies, such as using an active driving motor to move a lens set inside a camera module in order to carry out the function of two stage focusing, wherein the driving motor can be a voice coil motor (VCM), a stepping motor, a piezoelectric motor, and etc. However, the component cost of the driving motor and the entire volume of the camera module will be apparently increased, and therefore leave a room for further improvements.

It is therefore tried by the inventor to develop a dual-focus lens and an electronic device having the same to solve the problems existing in the traditional camera lens as described above.

### SUMMARY OF INVENTION

A primary object of the present invention is to provide a dual-focus lens and an electronic device having the same, which is only provided with a single lens set that can form a clear image in a first focus and a second focus to carry out a function of double focusing without shifting any lens or a rear focus of the lens set.

To achieve the above object, the dual-focus lens of a preferred embodiment of the present invention is characterized in that the dual-focus lens can achieve a purpose of taking a clear picture at a long distance (i.e. a normal-distance) or a short distance (i.e. a macro-distance), so as to solve the problem existing in the traditional camera lens that the component cost of the driving motor for driving the lens set and the entire volume of the camera lens are increased.

In order to achieve aforementioned objects, the present invention discloses a dual-focus lens that includes a stop and at least two lenses. One of the lenses is relatively close to the stop, and formed with a first transmission area and a second transmission area. When the at least two lenses are fixed without shifting any lens, an image beam reflected from a first object distance can pass through the first transmission area to form a clear optical image on an image formation area located at a fixed position, and an image beam reflected from a second object distance can pass through the second transmission area to form a clear optical image on the same image formation area, so as to achieve a purpose of providing double focuses without any active elements or changing the image formation distance. Physical structures of the first transmission area and the second transmission area can be selected from the group consisting of two different thickness areas formed on an inner circle and an outer ring of one of said lenses, two different curvature areas formed on the inner circle and the outer ring, a glass having an inner circular opening close to one of said lenses to substantially provide two different thickness areas, and one Fresnel lens area and one normal lens area formed on the inner circle or the outer ring to provide two different curvature areas.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing a conventional lens set having a fixed focus;

FIG. 2 is a chart of a Modulation Transfer Function (MTF) test of the conventional lens set as shown in FIG. 1;

FIG. 3 is a schematic view of a dual-focus lens according to a preferred embodiment of the present invention;

FIG. 4 is a schematic view of a dual-focus lens provided with a lens having a first transmission area and a second transmission area according to a first preferred embodiment of the present invention;

FIG. 5 is a chart of a MTF test of the dual-focus lens according to the first preferred embodiment of the present invention as shown in FIG. 4;

FIG. 6 is a diagram of an optical path simulation at a macro distance (i.e. a short distance) of the dual-focus lens according to the first preferred embodiment of the present invention as shown in FIG. 4;

FIG. 7 is a diagram of an optical path simulation at a normal distance (i.e. an average-distance) of the dual-focus lens according to the first preferred embodiment of the present invention as shown in FIG. 4;

FIG. 8 is a diagram of a dual-focus lens provided with a lens having a first transmission area and a second transmission area according to a second preferred embodiment of the present invention;

FIG. 9 is a chart of a MTF test of the dual-focus lens according to the second preferred embodiment of the present invention as shown in FIG. 8;

FIG. 10 is a cross-sectional view of a dual-focus lens provided with a lens having a first transmission area and a second transmission area according to a third preferred embodiment of the present invention;

FIG. 11 is a cross-sectional view of a dual-focus lens provided with a lens having a first transmission area and a second transmission area according to a fourth preferred embodiment of the present invention;

FIG. 12 is a cross-sectional view of a dual-focus lens provided with a lens having a first transmission area and a second transmission area according to a fifth preferred embodiment of the present invention;

FIG. 13 is a cross-sectional view of a dual-focus lens provided with a lens having a first transmission area and a second transmission area according to a sixth preferred embodiment of the present invention; and

FIG. 14 is a diagram of a dual-focus lens provided with a lens having a first transmission area and a second transmission area according to a seventh preferred embodiment of the present invention.

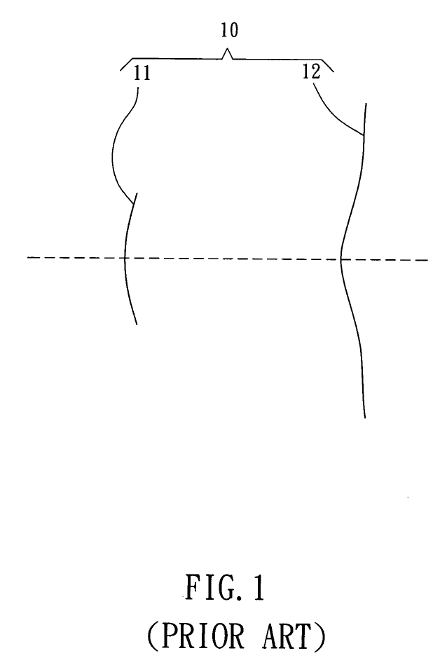

### DETAILED DESCRIPTION

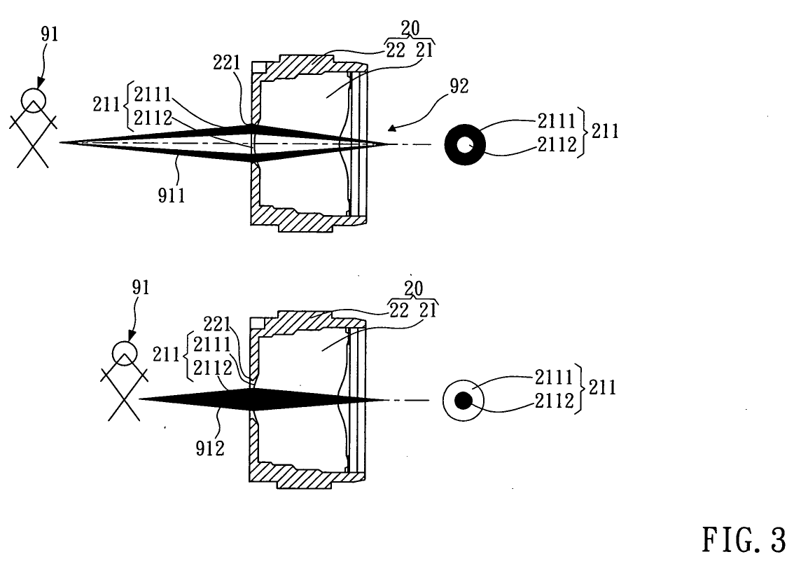

Referring to FIG. 3, a dual-focus lens 20 according to a preferred embodiment of the present invention is illustrated. As shown, the dual-focus lens 20 comprises a lens set 21 including a plurality of lenses, and a hollow lens base 22 for receiving and positioning the lenses of the lens set 21 therein. The dual-focus lens 20 is used to form a clear optical image of an object 91 on an image formation area 92, wherein the image formation area 92 is preferably an active surface of an image sensor chip for converting the optical image of the object 91 into an electrical signal capable of being recognized by a computer, so as to carry out a function of digital camera. In the preferred embodiment of the present invention, the image sensor chip can be selected from a charge coupled device (CCD) sensor or a complementary metal-oxide semiconductor (CMOS) sensor. Furthermore, because the dual-focus lens 20 of the present invention is advantageous to minimize the entire volume, the dual-focus lens 20 is suitably applied to various portable electronic devices, such as mobile phones or personal digital assistants (PDAs).

Referring still to FIG. 3, in the preferred embodiment of the present invention, the hollow lens base 22 has a front side relatively close to the object 91 located at an external environment, and the front side is provided with a stop 221 that is aligned with the lens set 21 including the plurality of lenses. Meanwhile, the lens set 21 includes a lens (i.e. a first lens) relatively close to the stop 221, and the first lens has a surface 211 (i.e. a first surface) formed with a first transmission area 2111 and a second transmission area 2112. The first transmission area 2111 and the second transmission area 2112 are constructed by providing at least two different physical structures on the surface 211, such as changing the thickness or curvature of the first lens without limitation, so as to achieve a purpose of providing an optical path difference on the first transmission area 2111 and the second transmission area 2112 of the same surface 211 (i.e. providing different amplification factors due to having different lengths of optical paths). As shown in FIG. 3, in the preferred embodiment of the present invention, the first transmission area 2111 and the second transmission area 2112 are concentrically arranged, wherein the first transmission area 2111 is formed on an outer peripheral area (i.e. an outer ring) of the first lens and provides a relatively smaller amplification factor, while the second transmission area 2112 is formed on a central area (i.e. an inner circle) of the first lens and provides a relatively greater amplification factor.

Referring now to an upper half part of FIG. 3, in the preferred embodiment of the present invention, when the object 91 is located at a normal distance (i.e. a first object distance), such as the object 91 is apart from the dual-focus lens 20 of the present invention about several meters (for ex., 2 meters or more), most of image beams 911 reflected from the object 91 will project into the dual-focus lens 20 through the stop 221 and the first transmission area 2111 of the first lens, so as to form a clear optical image on the image formation area 92. Furthermore, referring now to a lower half part of FIG. 3, in the preferred embodiment of the present invention, when the object 91 is located at a macro distance (i.e. a second object distance), such as the object 91 is only apart from the dual-focus lens 20 of the present invention about several tens of centimeters (for ex., within 80 centimeters), most of image beams 912 reflected from the object 91 will project into the dual-focus lens 20 via the stop 221 and the second transmission area 2112 of the first lens, so as to form another clear optical image on the same image formation area 92. As a result, even though the dual-focus lens 20 of the present invention completely needs not shift any lens of the lens set 21, or change the location or relative distance of the image formation area 92, the dual-focus lens 20 can still form the clear optical image when the object 91 is at two different object locations.

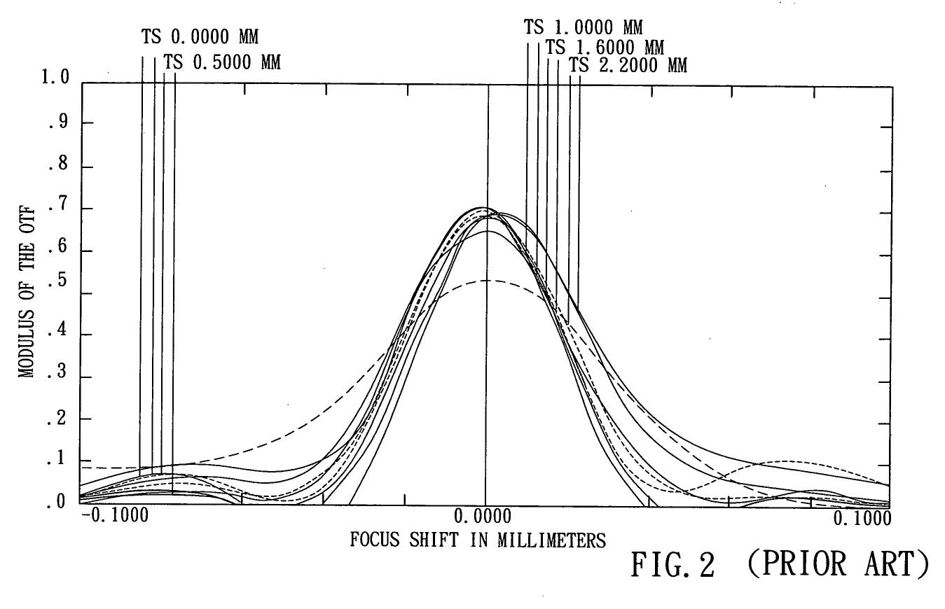

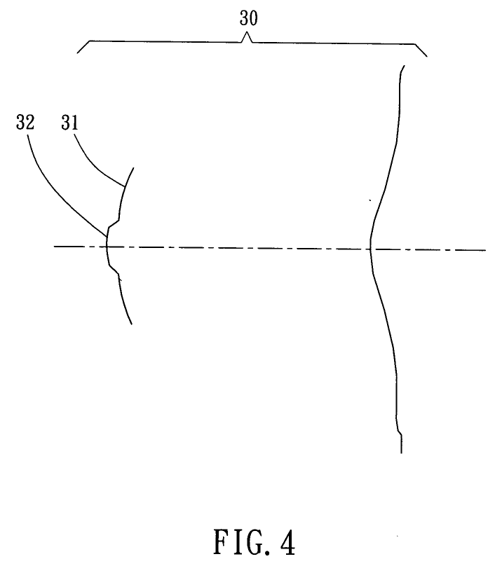

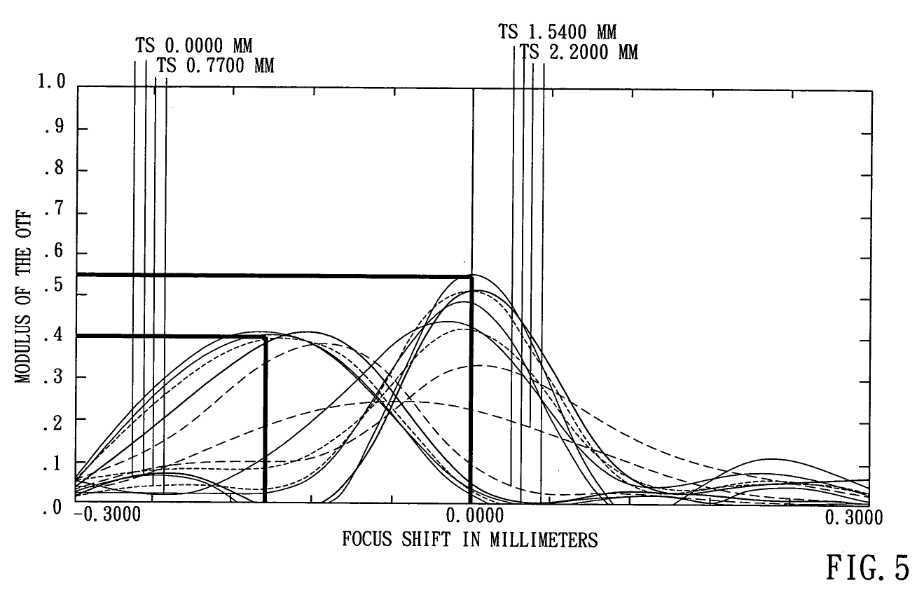

Referring now to FIG. 4, a dual-focus lens 30 provided with a lens having a first transmission area 31 and a second transmission area 32 according to a first preferred embodiment of the present invention is illustrated. As shown in FIG. 4, the lens having the first transmission area 31 and the second transmission area 32 according to the first preferred embodiment is constructed by providing two different thicknesses of a front surface of the lens relatively close to the stop 221, wherein the first transmission area 31 is disposed on an outer peripheral area (i.e. an outer lens ring) of the lens and provides a smaller thickness, while the second transmission area 32 is disposed on a central area (i.e. an inner lens circle) of the lens and provides a greater thickness. As a result, the single dual-focus lens 30 can carry out a function of simultaneously providing two different amplification factors (i.e. providing an optical path difference). Referring now to FIG. 5, a chart of a Modulation Transfer Function (MTF) test of the dual-focus lens 30 according to the first preferred embodiment of the present invention as shown in FIG. 4 is illustrated, wherein a lens of 2 million pixel resolution that has a stop relatively close to the object is used as a sample and applied to the dual-focus lens 30 of the present invention as shown in FIG. 4 for executing the test under test conditions the same as that of FIG. 2. As shown in FIG. 5, the dual-focus lens 30 of the present invention can apparently provide two peak values at two different locations. In other words, the dual-focus lens 30 can respectively form a clear optical image on the two different locations. When an object is located at a normal distance, most of an image beam can be formed into a clear optical image on an image formation area by passing through the first transmission area 31, while a part of the image beam can also be formed into another optical image on the image formation area by passing through the second transmission area 32. Nevertheless, in the chart of MTF test as shown in FIG. 5, when a focus shift value on a transverse axle of the chart is equal to about 0, the image beam of the clear optical image passed through the first transmission area 31 has a maximum peak value (about 0.55) of an Optical Transfer Function (OTF) modulus, but the non-focused image beam of the optical image passed through the second transmission area 32 only has a OTF peak value about 0.03, i.e. the optical image passed through the second transmission area 32 cannot affect the image quality of the clear optical image passed through the first transmission area 31. On the other hand, when the object is located at a macro distance, it will generate a similar result of image formations. In other words, the image beam of the clear optical image passed through the second transmission area 32 has a maximum OTF peak value about 0.4, but the non-focused image beam of the optical image passed through the first transmission area 31 only has a OTF peak value about 0. For portable electronic devices (such as mobile camera phones) which emphasize on the miniaturization and the low price trend in stead of the image quality, the dual-focus lens 30 of the present invention can provide enough image qualities for satisfying most of consumers and being accepted by the consumers.

In a preferred embodiment of the present invention, the first transmission area and the second transmission area of the dual-focus lens of the present invention have setting values which can be calculated by the following rules:

1. According to a trend, a boundary between the first transmission area and the second transmission area is preferably located at a location ranged from ⅕ to ¾ of a maximum stop value of a common lens, especially a location ranged from ¼ to ½ of the maximum stop value, so that the present invention can not only provide two more perfect curve lines in the chart of the MTF test, but also enhance the image quality and brightness of the dual-focus lens. For example, if an outer diameter of the second transmission area (i.e. an inner circle) is defined as Di, and a maximum outer diameter (or a maximum stop value) of the first transmission area (i.e. an outer ring) is defined as Do, the relationship of Di and Do is preferably calculated by an equation: ⅕Do<Di<¾ Do, especially by an equation: ¼Do<Di<½Do.

2. The first transmission area and the second transmission area of the common lens are preferably located at a common lens selected from a front lens or a last lens, which is relatively close to the stop. As a result, the image beam of the optical image can be relatively concentrated on and passed through the first transmission area and the second transmission area. For example, if a location of the stop in the hollow lens base of the dual-focus lens is defined as Si (where “i” is the order of location of the stop), and a surface location of the lens having the first transmission area and the second transmission area is defined as Sj (where “j” is the order of location of the surface), then the dual-focus lens of the present invention is operatable when |i−j|≦3, and better performance can be obtained by the dual-focus lens of the present invention especially when |i−j|≦2.

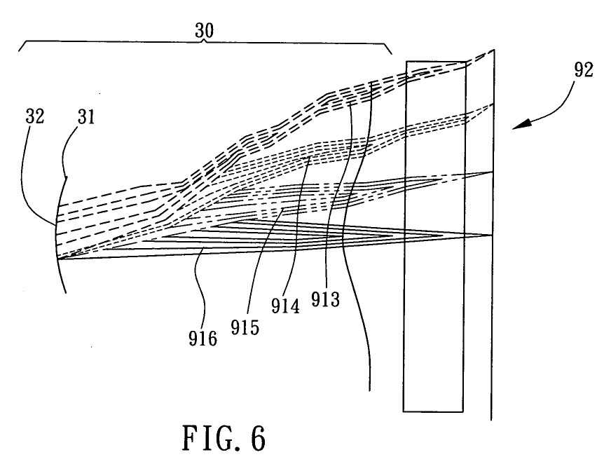

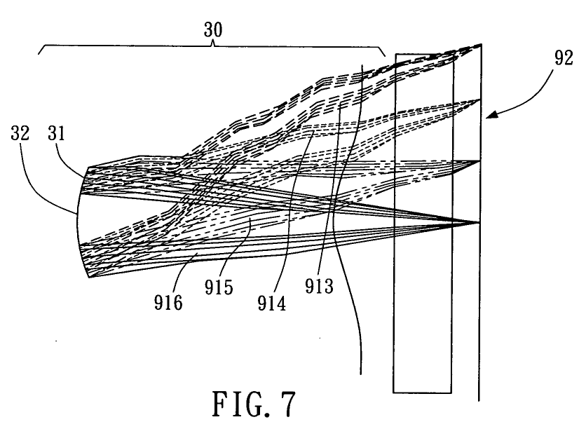

Referring now to FIGS. 6 and 7, two diagrams of an optical path simulation at a macro distance (i.e. a short distance) or a normal distance (i.e. an average-distance) of the dual-focus lens 30 according to the first preferred embodiment of the present invention as shown in FIG. 4 are illustrated, respectively. As shown in FIG. 6, when the object is located at the macro distance (for short-distance photographing), a plurality of image beams 913, 914, 915, 916 reflected from different objective fields are respectively formed on different locations on the image formation area 92 through the second transmission area 32 of the lens. As shown in FIG. 7, when the object is located at the normal distance (for long-distance photographing), a plurality of image beams 913, 914, 915, 916 reflected from different objective fields are respectively focused/formed on different locations on the image formation area 92 through the first transmission area 31 of the lens.

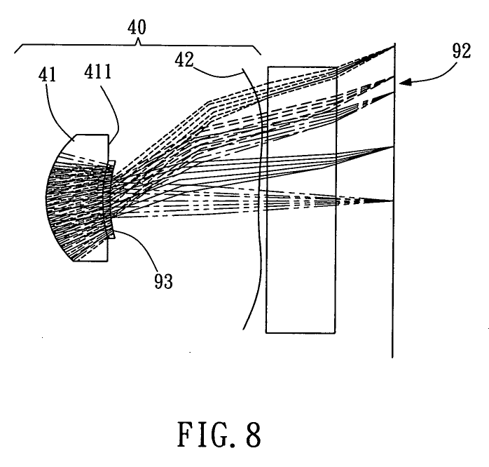

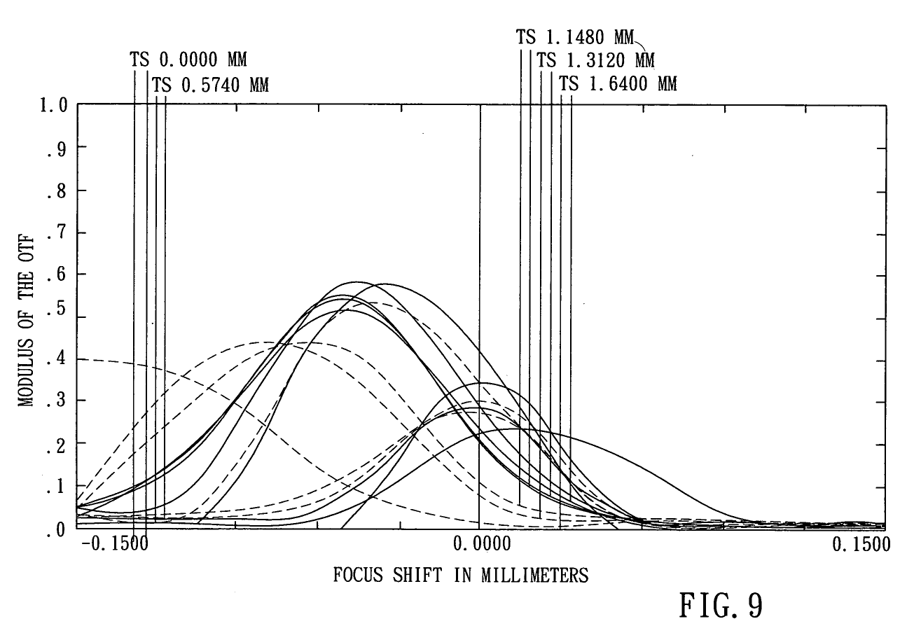

Referring now to FIG. 8, a diagram of a dual-focus lens 40 provided with a lens 41 having a first transmission area and a second transmission area according to a second preferred embodiment of the present invention is illustrated, wherein a lens of 1.3 million pixel resolution is used as a sample which has a stop 93 located between the lens 41 and a lens 42 of the dual-focus lens 40. Moreover, according to the dual-focus lens 40 of the present invention, the first transmission area and a second transmission area are formed on a surface 411 of the lens 41 on a front side (i.e. a left side) of the stop 93. Furthermore, a diagram of an optical path simulation of the dual-focus lens 40 according to the second preferred embodiment of the present invention is illustrated in FIG. 8, and a chart of a MTF test is as shown in FIG. 9. Referring to FIG. 9, even though the stop 93 of the dual-focus lens 40 is located between the lens 41 and the lens 42, the dual-focus lens 40 of the present invention can still carry out a function of forming two peak values, i.e. two focuses.

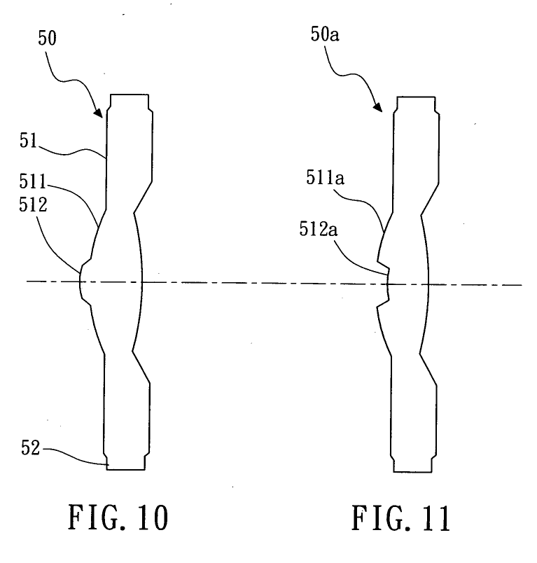

Referring now to FIG. 10, a dual-focus lens provided with a lens having a first transmission area and a second transmission area according to a third preferred embodiment of the present invention is illustrated. As shown, the lens designated by numeral 50 has a left side surface 51 (i.e. a side surface relatively close to a aperture), which is formed with an outer ring defined as the first transmission area 511 having a relatively smaller thickness, so that an image beam of an object at a normal distance (for long-distance photographing) can pass through the first transmission area 511 to form a clear optical image on an image formation area of the dual-focus lens. Meanwhile, the left side surface 51 of the lens 50 is further formed with an inner circle defined as the second transmission area 512 having a relatively greater thickness. Thus, an optical path difference is formed between the first transmission area 511 and the second transmission area 512, so that an image beam of an object at a macro distance (for short-distance photographing) can pass through the second transmission area 512 to form a clear optical image on the image formation area of the dual-focus lens. In the third preferred embodiment of the present invention, the first transmission area 511 and the second transmission area 512 are concentrically arranged on the common side surface 51 of the lens 50, while the first transmission area 511 and the second transmission area 512 have the same curvature (i.e. optical surface parameters). Moreover, the side surface 51 of the lens 50 is further formed with an outermost periphery defined as a ring-like positioning structure 52, for being engaged with and positioned in a lens base 22 as shown in FIG. 3.

Referring now to FIG. 11, a dual-focus lens provided with a lens 50a having a first transmission area and a second transmission area according to a fourth preferred embodiment of the present invention is illustrated. As shown, the lens 50a has a side surface formed with an outer ring defined as the first transmission area 511a having a relatively greater thickness, so that an image beam of an object at a macro distance (for short-distance photographing) can pass through the first transmission area 511a to form a clear optical image on an image formation area of the dual-focus lens. Meanwhile, the side surface of the lens 50a is further formed with an inner circle defined as the second transmission area 512a having a relatively smaller thickness, so that an image beam of an object at a normal distance (for long-distance photographing) can pass through the second transmission area 512a to form a clear optical image on the image formation area of the dual-focus lens.

In an alternatively preferred embodiment of the present invention (not shown), the second transmission area formed on the inner circle of the lens has an optical surface parameter which can be re-design, so that the first transmission area formed on the outer ring and the second transmission area formed on the inner circle will have a similar thickness but have different optical surface parameters. Due to different optical surface parameters of the first transmission area and the second transmission area, the present invention can still carry out a function of double focusing. However, the lens structure of the alternatively preferred embodiment inevitably has a slight thickness variation due to different curvature radiuses.

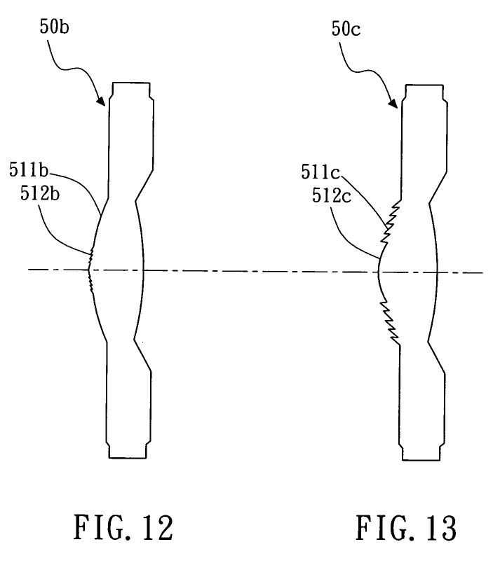

Referring now to FIG. 12, a dual-focus lens provided with a lens having a first transmission area and a second transmission area according to a fifth preferred embodiment of the present invention is illustrated. As shown, the lens designated by numeral 50b has a side surface formed with an outer ring defined as the first transmission area 511b having a normal optical surface parameter (i.e. curvature), so that an image beam of an object at a normal distance (for long-distance photographing) can pass through the first transmission area 511b to form a clear optical image on an image formation area of the dual-focus lens. Meanwhile, the side surface of the lens 50b is further formed with an inner circle defined as the second transmission area 512b selected from a Fresnel lens which can change an optical surface parameter (i.e. curvature) thereof under a similar thickness, so that an image beam of an object at a macro distance (for short-distance photographing) can pass through the second transmission area 512b to form a clear optical image on the image formation area of the dual-focus lens. As a result, the thickness of the outer ring will be close to that of the inner circle, so as to decrease the sectional difference between the first transmission area 511b and the second transmission area 512b.

Referring now to FIG. 13, a dual-focus lens provided with a lens 50c having a first transmission area and a second transmission area according to a sixth preferred embodiment of the present invention is illustrated. As shown, the lens 50c has a side surface formed with an outer ring defined as the first transmission area 511c selected from a Fresnel lens for providing a relatively greater amplification factor, so that an image beam of an object at a macro distance (for short-distance photographing) can pass through the first transmission area 511c to form a clear optical image on an image formation area of the dual-focus lens. Meanwhile, the side surface of the lens 50c is further formed with an inner circle defined as the second transmission area 512c selected from a normal lens, so that an image beam of an object at a normal distance (for long-distance photographing) can pass through the second transmission area 512c to form a clear optical image on the image formation area of the double-focusing lens. As a result, the thickness of the outer ring will be close to that of the inner circle, so as to decrease the sectional difference between the first transmission area 511c and the second transmission area 512c.

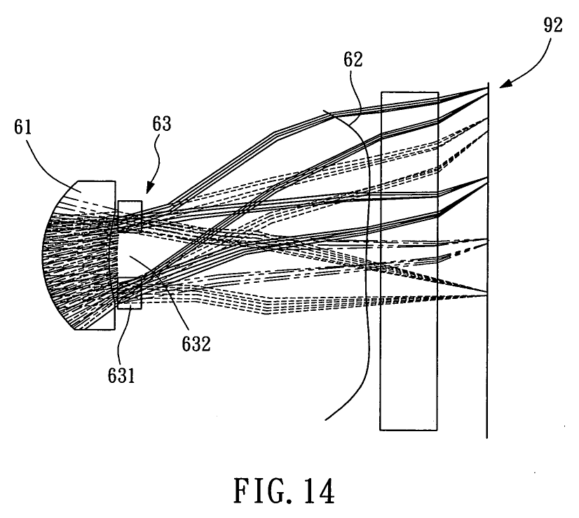

Referring now to FIG. 14, a dual-focus lens provided with a lens having a first transmission area and a second transmission area according to a seventh preferred embodiment of the present invention is illustrated. As shown, a transparent thin planar optical material 63, such as a planar glass, is disposed between a first lens 61 and a second lens 62, and closed to the stop. The thin planar optical material 63 is formed with an inner circular opening 632 surrounded by an outer ring 631 of the thin planar optical material 63, wherein a thickness difference is substantially defined between the inner circular opening 632 and the outer ring 631 of the thin planar optical material 63, so that an image beam of an object can pass through the inner circular opening 632 (i.e. the second transmission area) and the outer ring 631 (i.e. the first transmission area) of the thin planar optical material 63 to provide different lengths of optical paths, for the purpose of double focusing.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A dual-focus lens, comprising:
a lens base;
a stop; and
at least one lens received in the lens base and corresponding to the stop, wherein one of the at least one lens is formed with a first transmission area and a second transmission area having different lengths of optical paths.

2. The dual-focus lens of claim 1, wherein the first transmission area and the second transmission area are two different physical structures formed on a surface of said lens, so as to provide an optical path difference therebetween.

3. The dual-focus lens of claim 2, wherein the physical structures of the first transmission area and the second transmission area to provide the optical path difference are selected from a group comprising: two different thickness areas formed on said lens, two different areas having different optical surface parameters formed on said lens, one Fresnel lens area and one normal lens area formed on said lens, and a thin planar optical material having an inner circular opening close to said lens.

4. The dual-focus lens of claim 1, wherein the first transmission area and the second transmission area are concentrically arranged, and the first transmission area is formed on an outer ring of said lens, and the second transmission area is formed on an inner circle of said lens.

5. The dual-focus lens of claim 4, wherein an outer diameter of the second transmission area is defined as Di and a maximum outer diameter of the first transmission area is defined as Do, and the relationship of Di and Do is ⅕Do<Di<¾Do.

6. The dual-focus lens of claim 1, wherein the first transmission area provides a relatively smaller amplification factor, and the second transmission area provides a relatively greater amplification factor.

7. The dual-focus lens of claim 1, wherein the first transmission area provides a relatively greater amplification factor, and the second transmission area provides a relatively smaller amplification factor.

8. The dual-focus lens of claim 1, wherein when an object is located at a first object distance, an image beam of the object projects into the dual-focus lens through the first transmission area to form a clear optical image on an image formation area of the dual-focus lens without shifting any lens; and when the object is located at a second object distance, an image beam of the object projects into the dual-focus lens through the second transmission area to form a clear optical image on the same image formation area without shifting any lens.

9. The dual-focus lens of claim 8, wherein the first object distance is 2 meters or more, and the second object distance is within 80 centimeters.

10. The dual-focus lens of claim 1, wherein a location of the stop in the lens base is defined as Si and a surface location of said lens having the first transmission area and the second transmission area is defined as Sj, wherein |i−j|≦2.

11. The dual-focus lens of claim 10, wherein the surface location of said lens having the first transmission area and the second transmission area is a location relatively close to the stop.

12. An electronic device having a dual-focus lens, comprising:
a stop;
an image formation area being an active surface of an image sensor chip; and
at least one lens corresponding to the stop and the image formation area, wherein one of the at least one lens is formed with a first transmission area and a second transmission area having different lengths of optical paths.

13. The electronic device having the dual-focus lens of claim 12, wherein the electronic device is a mobile phone having a digital camera.

14. The electronic device having the dual-focus lens of claim 12, wherein the image sensor chip is a charge coupled device (CCD) or a complementary metal-oxide semiconductor (CMOS).

15. The electronic device of claim 12, wherein physical structures of the first transmission area and the second transmission area are selected from a group comprising: two different thickness areas formed on said lens, two different areas having different optical surface parameters formed on said lens, one Fresnel lens area and one normal lens area formed on said lens, and a thin planar optical material having an inner circular opening close to said lens.

16. The electronic device of claim 12, wherein the first transmission area and the second transmission area are concentrically arranged, and the first transmission area is formed on an outer ring of said lens, and the second transmission area is formed on an inner circle of said lens; wherein an outer diameter of the second transmission area is defined as Di and a maximum outer diameter of the first transmission area is defined as Do, and the relationship of Di and Do is ⅕Do<Di<¾Do.

17. The electronic device of claim 12, wherein when an object is located at a first object distance, an image beam of the object projects into the lens through the first transmission area to form a clear optical image on an image formation area of the lens without shifting any lens; and when the object is located at a second object distance, an image beam of the object projects into the lens through the second transmission area to form a clear optical image on the same image formation area without shifting any lens.

18. The electronic device of claim 12, wherein a location of the stop in the lens base is defined as Si and a surface location of said lens having the first transmission area and the second transmission area is defined as Sj, wherein |i−j|≦2.

19. A dual-focus lens, comprising:
a stop; and
at least two lenses corresponding to the stop, wherein an image beam of an object located at an external environment can pass through the stop and the lenses to form an optical image on an image formation area, characterized in that:
at least one of the lenses is formed with a first transmission area and a second transmission area; when the object is located at a first object distance, the image beam of the object projects into the dual-focus lens through the first transmission area to form the clear optical image on the image formation area without shifting any lens; and when the object is located at a second object distance, the image beam of the object projects into the dual-focus lens through the second transmission area to form the clear optical image on the same image formation area without shifting any lens.

20. The dual-focus lens of claim 19, wherein physical structures of the first transmission area and the second transmission area are selected from a group comprising: two different thickness areas formed on said lens, two different areas having different optical surface parameters formed on said lens, one Fresnel lens area and one normal lens area formed on said lens, and a thin planar optical material having an inner circular opening close to said lens.
